(19) United States
(12) Patent Application Publication
(10) Pub. No.: US 2016/0179190 A1
(43) Pub. Date: Jun. 23, 2016

(54) METHOD AND APPARATUS FOR ESTIMATING POSITION OF PEDESTRIAN WALKING ON LOCOMOTION INTERFACE DEVICE

(71) Applicant: ELECTRONICS AND TELECOMMUNICATIONS RESEARCH INSTITUTE, Daejeon (KR)

(72) Inventors: So-Yeon Lee, Daejeon (KR); Sang-Joon Park, Daejeon (KR); Yang-Koo Lee, Daejeon (KR); Chan-Gook Park, Seoul (KR); Min-Su Lee, Busan (KR); Ho-Jin Ju, Busan (KR)

(21) Appl. No.: 14/602,467

(22) Filed: Jan. 22, 2015

(30) Foreign Application Priority Data
Dec. 19, 2014 (KR) 10-2014-0184803

(51) Int. Cl. G06F 3/01; G06K 9/00; G06F 3/03

(52) U.S. Cl. CPC G06F 3/011; G06F 3/03; G06K 9/00771; G06F 2203/012

(57) ABSTRACT

Provided are a method and apparatus for estimating a position of a pedestrian in a virtual reality. A method of estimating a position of a pedestrian walking on a locomotion interface device includes detecting a stance phase based on first sensed data; receiving driving speed information of the locomotion interface device from the locomotion interface device; and estimating a step length of the pedestrian based on second sensed data, in which the step length is estimated in consideration of a driving speed of the locomotion interface device in the stance phase. It is possible to estimate a distance actually traveled by a pedestrian and a position of the pedestrian in a virtual reality.

### CROSS-REFERENCE TO RELATED APPLICATION

This application claims priority to and the benefit of Korean Patent Application No. 2014-0184803, filed on Dec. 19, 2014, the disclosure of which is incorporated herein by reference in its entirety.

### BACKGROUND

1. Field of the Invention

Embodiments of the present invention relates to a method and apparatus for estimating a position of a pedestrian walking on a locomotion interface device under a virtual reality environment.

2. Discussion of Related Art

A personal navigation system collectively refers to systems for locating a pedestrian. Among the systems, a pedestrian dead-reckoning (PDR) is a representative system for locating a pedestrian using only its own sensor without external assistance. In general, the PDR is a dead reckoning system that is developed on the assumption that a pedestrian changes his/her position by making a step.

The PDR finds a current position of a pedestrian using step information of the pedestrian. For example, the PDR finds a current position by estimating a movement distance and a heading of the pedestrian to apply the estimated data to an initial position of the pedestrian. The PDR is composed of step detection, step length estimation, and heading estimation.

The step detection is to detect a step of a pedestrian. In the step detection, an inertial sensor may be used. For example, when the inertial sensor is placed in a shoe of a pedestrian, the step detection may be performed by analyzing a pattern of data acquired by the inertial sensor. The step of the pedestrian may be divided into a stance phase and a swing phase. The stance phase is a period in which a shoe touches the ground, and the swing phase is a period in which a shoe moves with his/her foot.

The step length estimation and the heading estimation are to estimate a step length and a heading of a pedestrian based on the detected step information. In general, a zero velocity update (ZUPT) is used to estimate the step length and the heading. The ZUPT is a method that uses the fact that a shoe speed is zero in the stance phase.

FIG. 1 shows an example of an omnidirectional locomotion interface device. A locomotion interface device 20 is a device for implementing virtual reality and operating according to a movement speed and a heading of a pedestrian 10, allowing the pedestrian not to depart from a limited region on the locomotion interface device 20. For example, it is assumed that the pedestrian 10 moves 1 meter in an outward direction of the locomotion interface device 20 (a direction of a centrifugal force). In this case, the locomotion interface device 20 senses movement of the pedestrian 10 and moves a top plate of the locomotion interface device 20 by one meter in an inward direction thereof (a direction of a centripetal force) to return the pedestrian 10 to an initial position.

The existing PDR using step characteristics of a pedestrian estimates a position of the pedestrian through step detection, step length estimation, and heading estimation. However, when a pedestrian makes a step on the locomotion interface device for implementing virtual reality, the pedestrian walks in place because the locomotion interface device is driven in a direction opposite to a heading of the pedestrian. Also, since a speed of a shoe is not zero even when the shoe is in contact with the locomotion interface device while the locomotion interface device is driven, a conventional ZUPT cannot be applied without any change.

### SUMMARY

The present invention is directed to a solution for estimating a step length, a heading, and a position of a pedestrian even when the pedestrian walks on the locomotion interface device.

According to an aspect of the present invention, there is provided a method of estimating a position of a pedestrian walking on a locomotion interface device, the method including detecting a stance phase based on first sensed data, receiving driving speed information of the locomotion interface device from the locomotion interface device, and estimating a step length of the pedestrian based on second sensed data, in which the step length is estimated in consideration of a driving speed of the locomotion interface device in the stance phase.

According to another aspect of the present invention, there is provided an apparatus for estimating a position of a pedestrian walking on a locomotion interface device, the apparatus including a communication unit configured to receive a driving speed of the locomotion interface device from the locomotion interface device; and a step length calculation unit configured to detect a stance phase based on first sensed data acquired by a first inertial measurement unit (IMU) and estimate a step length of the pedestrian based on second sensed data acquired by the first IMU, in which the step length is estimated in consideration of a driving speed of the locomotion interface device in the stance phase.

The step length calculation unit may estimates the step length of the pedestrian by applying a Kalman filter to the second sensed data.

The first sensed data may include one or more gyro signals, and the step length calculation unit may detect, as the stance phase, a time period in which a magnitude of each gyro signal is less than a first threshold value and a variance of the gyro signals acquired during a predetermined time is less than a second threshold value.

The first threshold value and the second threshold value may be set in consideration of vibration generated by the locomotion interface device.

The step length calculation unit may analyze a signal pattern of the first sensed data to detect the stance phase.

The second sensed data may include a gyro signal and an acceleration signal.

The step length calculation unit may correct a speed of the pedestrian in the stance phase to the driving speed of the locomotion interface device to estimate the step length.

The step length calculation unit may correct the estimated step length by adding a distance that the locomotion interface device is driven during a predetermined time period to a step length that is estimated during the time period.

The apparatus may further include an azimuth angle calculation unit configured to estimate a heading of the pedestrian based on third sensed data acquired by a second IMU, in which a virtual position estimation unit estimates a position of a pedestrian in a virtual reality in further consideration of the estimated heading.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is an exemplary diagram showing an example of an omnidirectional locomotion interface device;

FIG. 2 is a block diagram showing a pedestrian position estimation apparatus according to an embodiment of the present invention;

FIG. 3 is a block diagram showing a pedestrian position estimation apparatus according to another embodiment of the present invention;

FIG. 4 is a flowchart showing a method of estimating a position according to another embodiment of the present invention;

FIG. 5 is an exemplary diagram showing a method of estimating a position according to another embodiment of the present invention;

FIG. 6 is an exemplary diagram showing a method of detecting a stance phase using a hidden Markov model (HMM) according to embodiments of the present invention; and

FIG. 7A and FIG. 7B are exemplary diagrams showing a process of correcting a step length according to embodiments of the present invention.

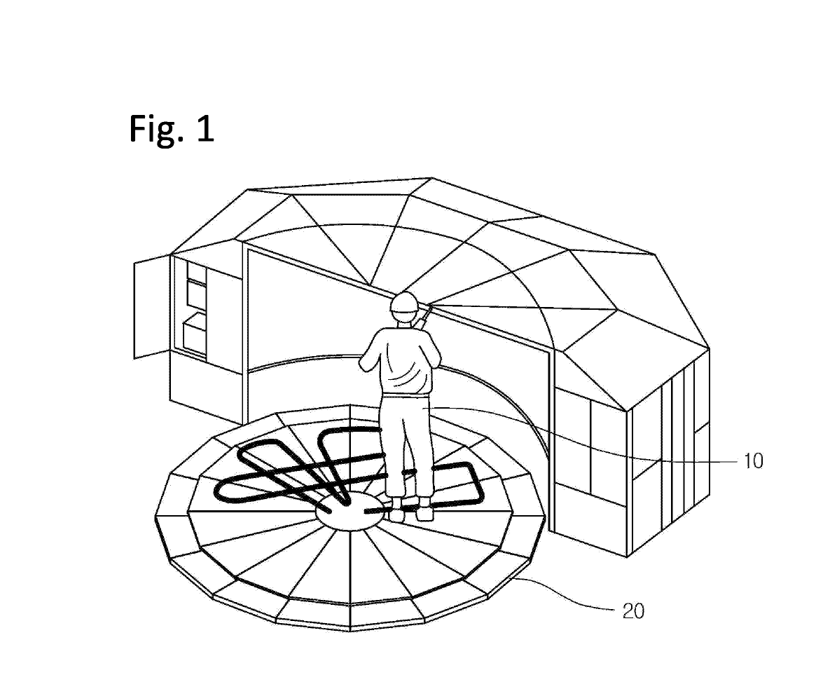

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

In the following description, when the detailed description of the relevant known function or configuration is determined to unnecessarily obscure the important point of the present invention, the detailed description will be omitted.

Embodiments of the present invention provide a solution for estimating a position of a pedestrian walking on a locomotion interface device.

In embodiments of the present invention, at least one inertial measurement unit (IMU) may be used to estimate a position of a pedestrian. The IMU may include at least one of a 3-axis accelerometer sensor, a 3-axis gyro sensor, and a geomagnetic sensor.

The IMU may be attached to a body of a pedestrian, for example, a foot of the pedestrian. The IMU may be additionally attached to various body parts, such as a waist, of the pedestrian. In this case, a skeleton-based location estimation method may be applied.

Alternatively, the IMU may be additionally placed in various clothes worn by the pedestrian. For example, the IMU may be placed in a shoe or belt worn by the pedestrian.

Alternatively, the IMU may be embedded in a user device possessed by the pedestrian. For example, the user device may be an electronic device such as a smartphone, a smart watch, a head mounted display (HMD).

Hereinafter, for convenience of explanation, it is assumed that one or two IMUs are attached to a shoe worn by a pedestrian or a shoe and a belt worn by a pedestrian.

Furthermore, it is also assumed that a pedestrian walks on a locomotion interface device (which may be at least one of a unidirectional locomotion interface device, a bidirectional locomotion interface device, and an omnidirectional locomotion interface device) and the locomotion interface device operates such that the pedestrian may stay at a certain position in a real world.

Hereinafter, embodiments of the present invention will be described with reference to the accompanying drawings.

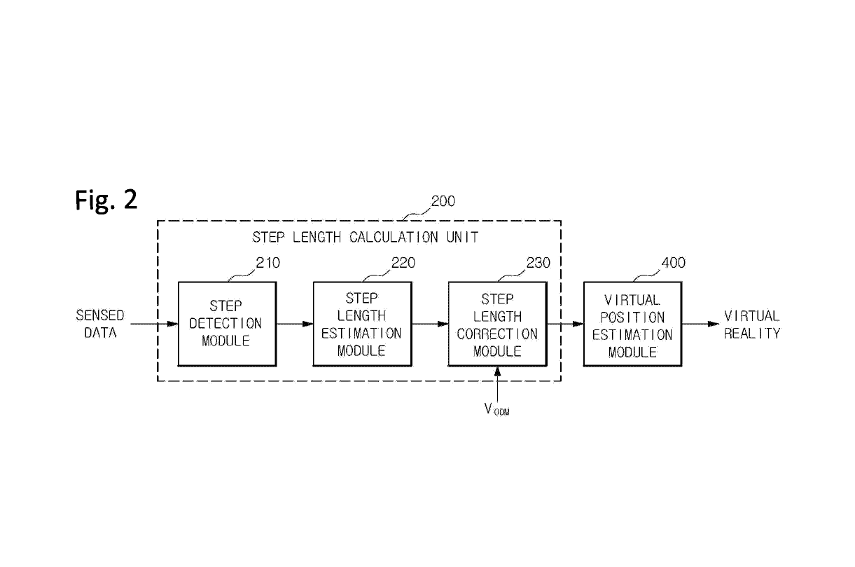

FIG. 2 is a block diagram showing a pedestrian position estimation apparatus according to an embodiment of the present invention. FIG. 2 shows an example of an apparatus for estimating a position of a pedestrian walking on a unidirectional or bidirectional locomotion interface device. In an embodiment described with reference to FIG. 2, it is assumed that an IMU is attached to a shoe worn by the pedestrian. Hereinafter, the IMU that is attached to the shoe worn by the pedestrian is referred to as a first IMU.

Referring to FIG. 2, the pedestrian position estimation apparatus according to an embodiment of the present invention includes a step length calculation unit 200 and a virtual position estimation unit 400. Depending on embodiments, at least one of the components shown in FIG. 2 may be omitted.

The step length calculation unit 200 includes a step detection module 210, a step length estimation module 220, and a step length correction module 230 and calculates a step length of a pedestrian based on data sensed by the first IMU and a driving speed of the locomotion interface device. Operations of respective modules will be described below.

The step detection module 210 detects a step based on the data sensed by the first IMU.

Depending on embodiments, one or two of the first IMUs may be attached to one or two shoes. When the first IMUs are attached to two shoes, the step detection may be performed based on each shoe. In other words, the step detection may be performed based on data sensed by a first IMU that is attached to a left shoe, and the step detection may be performed based on data sensed by a first IMU that is attached to a right shoe.

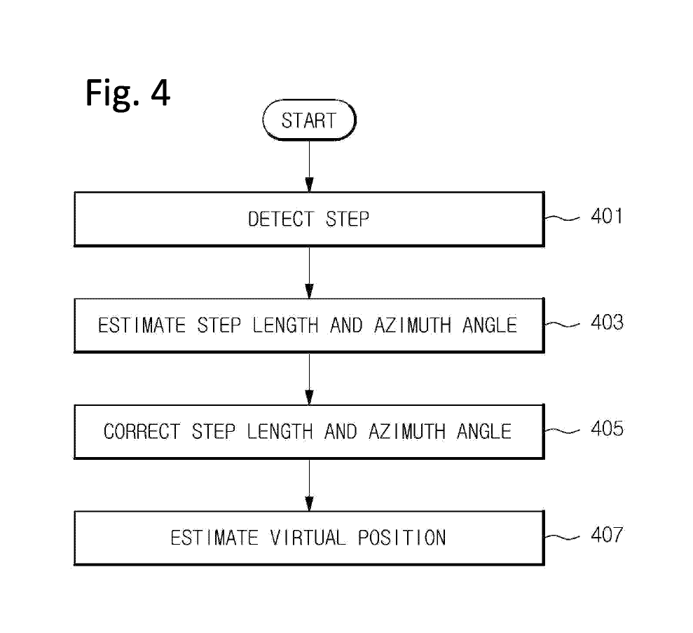

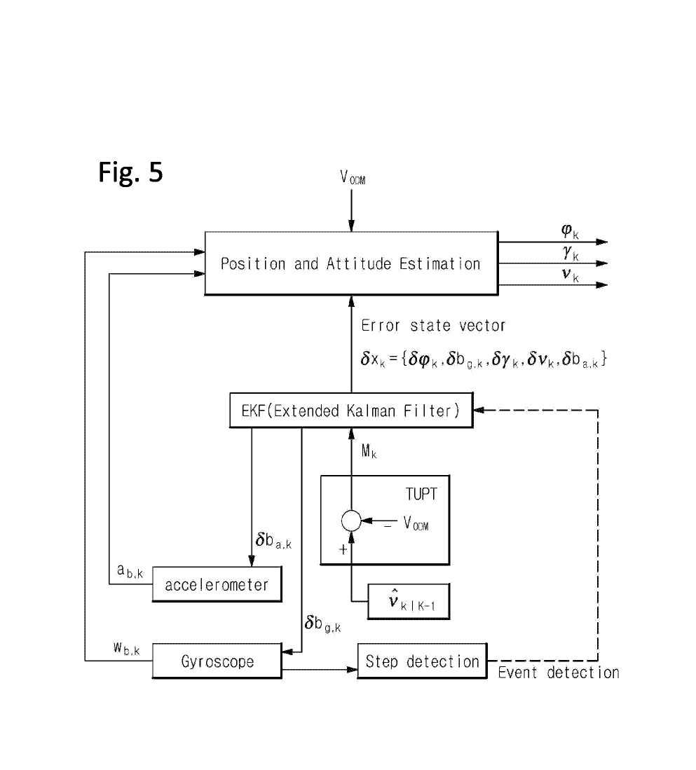

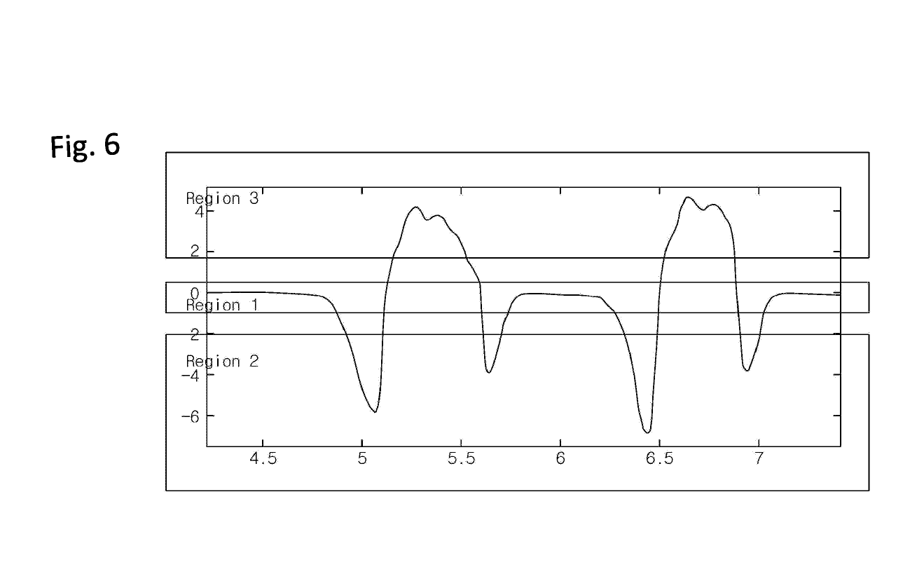

As described above, the step detection process includes a process of detecting a stance phase. The stance phase may be detected using various methods. For example, the stance phase may be detected depending on whether the data sensed by the first IMU satisfies a predetermined condition or may be detected through analysis of a pattern of the data sensed by the first IMU. This will be described in more detail with reference to FIG. 4, FIG. 5 and FIG. 6

The step length estimation module 220 estimates a step length of a pedestrian using a step detected by the step detection module 210. The step length of the pedestrian may be estimated using various methods, for example, applying a predetermined filter to the detected step. For example, an extended Kalman filter (EKF) or unscented Kalman filter (UKF) may be used for the step estimation. That is, the step length estimation module 220 may estimate the step length of the pedestrian by applying the EKF or UKF to the detected step.

The step length estimation module 220 considers a driving speed of the locomotion interface device when estimating the step length of the pedestrian. For example, the step length estimation module 220 may estimate the step length of the pedestrian on the assumption that a movement speed of a shoe in the stance phase is the driving speed of the locomotion interface device.

A method for performing the step length estimation in consideration of the driving speed of the locomotion interface device is referred to as a ‘modified ZUPT’ or ‘treadmill velocity update (TUPT).’ This will be described in more detail with reference to FIG. 4.

When respective first IMUs are attached to both shoes, the step length estimation may be performed based on each shoe.

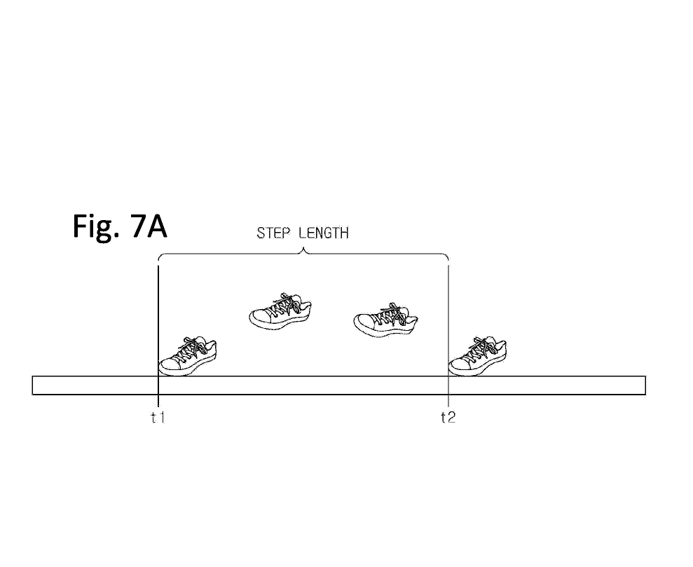

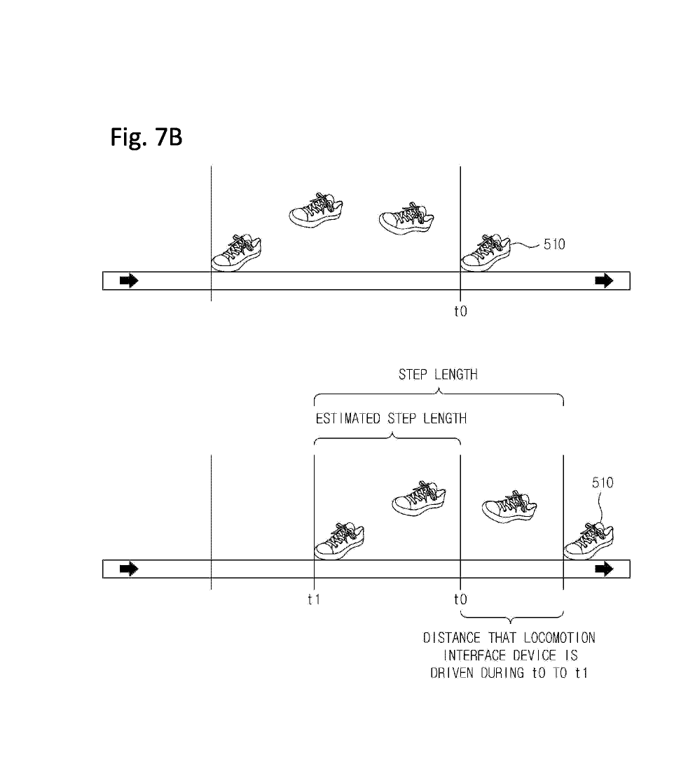

The step length correction module 230 corrects the step length based on the step length estimated by the step length estimation module 220 and a driving distance of the locomotion interface device. The step length correction is performed to remove an error occurring because the locomotion interface device is driven while the pedestrian walks thereon. The step length that is actually intended by a pedestrian may be found by performing the step length correction. This will be described in more detail with reference to FIG. 4 and FIG. 7.

The virtual position estimation unit 400 estimates a virtual position of the pedestrian based on the corrected step length. For example, the virtual position estimation unit 400 may estimate the virtual position by applying a currently estimated step length of the pedestrian to a previously estimated virtual position of the pedestrian.

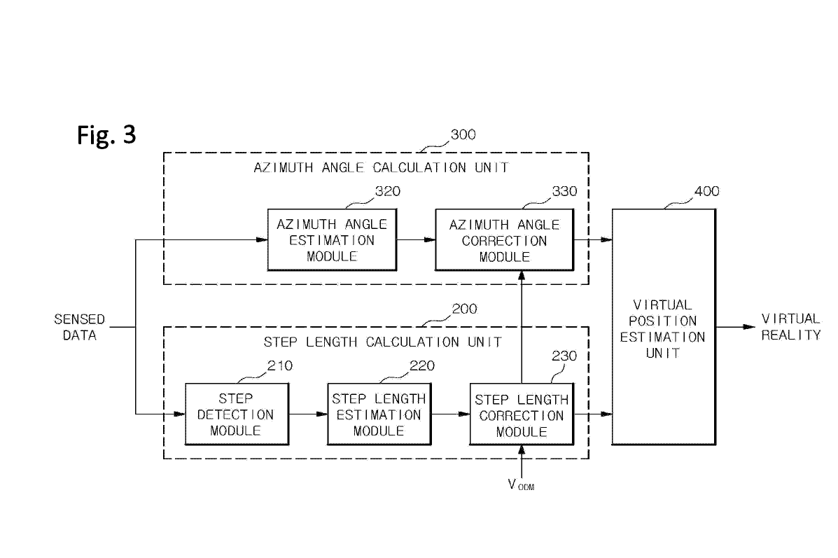

FIG. 3 is a block diagram showing a pedestrian position estimation apparatus according to another embodiment of the present invention. FIG. 3 shows an example of an apparatus for estimating a position of a pedestrian walking on an omnidirectional locomotion interface device. In an embodiment described with reference to FIG. 3, it is assumed that IMUs are attached to a shoe and a belt worn by the pedestrian. Hereinafter, the IMU that is attached to the shoe worn by the pedestrian is referred to as a first IMU, and the IMU that is attached to the belt worn by the pedestrian is referred to as a second IMU.

Referring to FIG. 3, the pedestrian position estimation apparatus according to an embodiment of the present invention includes a step length calculation unit 200, an azimuth angle calculation unit 300, and a virtual position estimation unit 400. Depending on embodiments, at least one of the components shown in FIG. 3 may be omitted.

Since a basic operation of the step length calculation unit 200 is the same as described with reference to FIG. 2, a detailed description thereof will be omitted.

The azimuth angle calculation unit 300 includes an azimuth angle estimation module 320 and an azimuth angle correction module 330 and calculates an azimuth angle, that is, a heading of the pedestrian based on data sensed by the first IMU and the second IMU and the step length corrected by the step length correction module 230. Operations of respective modules will be described below.

The azimuth angle estimation module 320 estimates an azimuth angle based on data sensed by at least one of the first IMU and the second IMU. The azimuth angle may be estimated using various methods, for example, applying a predetermined filter to data sensed from at least one of the first IMU and the second IMU. Used for the filter may be, for example, EKF or UKF. The azimuth angle estimation module 320 may estimate one azimuth angle that is based on the first IMU and one azimuth angle that is based on the second IMU. If respective first IMUs are attached to both shoes, the azimuth angle estimation module 320 may estimate two azimuth angles based on the first IMUs attached to the shoes.

The azimuth angle correction module 330 corrects an azimuth angle based on the azimuth angle estimated by the azimuth angle estimation module 320 and the step length corrected by the step length correction module 230.

To correct the azimuth angle, the azimuth angle correction module 330 may perform time synchronization between pieces of the reception data, that is, perform an operation such that the pieces of the reception data have the same time point. That is, the azimuth angle correction module 330 may perform time synchronization between data received from the azimuth angle estimation module 320 and data received from the step length correction module 230 and perform the azimuth angle correction based on the synchronized data received from the azimuth angle estimation module 320 and data received from the step length correction module 230.

Alternatively, the azimuth angle may be estimated and corrected based on only the data sensed by the second IMU.

The virtual position estimation unit 400 estimates a virtual position of the pedestrian based on the step length corrected by the step length correction module 230 and the azimuth angle corrected by the azimuth angle correction module 330.

FIG. 4 is a flowchart showing a method of estimating a position of a pedestrian according to another embodiment of the present invention, and FIG. 5 is an exemplary diagram showing a method of estimating a position of a pedestrian according to another embodiment of the present invention. In an embodiment described with reference to FIG. 4 and FIG. 5, it is assumed that a pedestrian position estimation apparatus estimates the position of the pedestrian based on data sensed by the first IMU attached to a shoe of a pedestrian and the second IMU attached to a belt of the pedestrian. Depending on embodiments, at least one of operations 401 to 407 may be omitted.

The pedestrian position estimation apparatus performs step detection (401).

The step detection may be performed based on data sensed by the first IMU. As described above, the step detection includes a process of detecting a stance phase. The stance phase may be detected based on an acceleration signal or gyro signal. In embodiments of the present invention, since the pedestrian walks on the driving locomotion interface device, the gyro signal may have a higher reliability than the acceleration signal. Here, an embodiment in which the stance phase is detected based on gyro signals will be described.

The stance phase may be detected based on a magnitude of each gyro signal and a variance of the gyro signals. For example, as shown in Equation 1, the pedestrian position estimation apparatus may determine a time period as the stance phase when a magnitude |Wₖ| of each of the gyro signals is less than a predetermined first threshold value th_{w} and a variance var(Wₖ₋₁₄:Wₖ) in a predetermined time period Wₖ₋₁₄:Wₖ is less than a predetermined second threshold value th_{var(w)}.

$${w}_{k} = \sqrt{{w}_{kx}^{2} + {w}_{ky}^{2} + {w}_{kz}^{2}} \\ {Condition}_{w} = \{ \begin{matrix}1 & \vert {w}_{k} \vert < {th}_{w} \\ 0 & otherwise\end{matrix} \\ {Condition}_{vw} = \{ \begin{matrix}1 & var ( {w}_{k - 14} : {w}_{k} ) < {th}_{var ( w )} \\ 0 & otherwise\end{matrix} \qquad [ Equation 1 ]$$

When Condition_{vw}·Condition_{w}=1, it is assumed to be stance phase where Wₖₓ, W_{ky}, and W_{kz} are magnitudes of the gyro signal in x, y, and z directions, respectively, k is a time index, and Wₖ₋₁₄:Wₖ are magnitudes of the gyro signals at time points k−14 to k.

The first threshold value th_{w} and the second threshold value th_{var(w)} may be determined in consideration of the influence of the locomotion interface device. For example, the first threshold value th_{w} and the second threshold value th_{var(w)} may be determined in consideration of the influence of vibration generated when the locomotion interface device is driven. That is, experimentally, the gyro signal is measured in the stance phase, and the first threshold value th_{w} and the second threshold value th_{var(w)} may be set based on the measured gyro signal.

The stance phase may be detected by analyzing a pattern of the gyro signals using various pattern recognition techniques. A hidden Markov model (HMM) may be used as one of the pattern recognition techniques. This is described with reference to FIG. 6.

FIG. 6 is an exemplary diagram showing a method of detecting a stance phase using a hidden Markov model (HMM) according to embodiments of the present invention.

In FIG. 6, a horizontal axis indicates a time, and a vertical axis indicates a gyro signal of a shoe pitch axis. The pedestrian position estimation apparatus may detect the stance phase by analyzing a pattern of the gyro signals during one step. FIG. 6 shows an example of performing the pattern analysis based the magnitude of the gyro signal. In the example of FIG. 6, region 1 is a period in which the magnitude of the gyro signal is close to zero, region 2 is a period in which the magnitude of the gyro signal is less than zero by a setting value or more, and region 3 is a period in which the magnitude of the gyro signal is more than zero by a setting value or more. In an example shown in FIG. 6, the pedestrian position estimation apparatus may detect, as the stance phase, a certain region in which the change in the gyro signal is relatively constant, that is, region 1.

Referring again to FIG. 4, the pedestrian position estimation apparatus estimates a step length and an azimuth angle (403).

A conventional INS-EKF-ZUPT technique may be modified and then used for the estimation of the step length. INS-EKF-ZUPT refers to an inertial navigation system (INS) in which an assumption that a speed of the pedestrian is zero while a foot is in contact with the ground is applied to an EKF. This will be described in more detail.

First, the INS and an error state vector are configured based on the data sensed by the first IMU. The INS may be configured through integration and gravity compensation of the acceleration signals and the gyro signals, which are included in the data sensed by the first IMU. For example, as shown in Equation 2, the error state vector δX_{k|k} may include errors δ in an attitude φₖ, a gyro bias b_{g,k}, a position rₖ, a speed vₖ, and an acceleration bias b_{a,k} as state variables.

δX_{k|k}=δXₖ=[δφₖ, δb_{g,k}, δrₖ, δvₖ, δb_{a,k}] [Equation 2]

When the IMUs are configured as micro-electro-mechanical system (MEMS) sensors, a dynamic model may be simplified as shown in Equation 3 and Equation 4.

$${Φ}_{k} = [ \begin{matrix}I & Δ t \cdot {C}_{{b}_{k \vert k - 1}}^{n} & 0 & 0 & 0 \\ 0 & I & 0 & 0 & 0 \\ 0 & 0 & I & Δ t \cdot I & 0 \\ - Δ t \cdot S ( {a}_{k}^{{}^{′} n} ) & 0 & 0 & I & Δ t \cdot {C}_{{b}_{k \vert k - 1}}^{n} \\ 0 & 0 & 0 & 0 & I\end{matrix} ] \qquad [ Equation 3 ]$$

where Φk is a state transition matrix at the time point k, I is an identity matrix, Δt is a sampling time, S(aₖ′ⁿ) is a skew symmetric matrix of an acceleration signal in a navigation frame, and Cⁿ_{bk|k-1} is a direction cosine matrix.

$$S ( {a}_{k}^{′ n} ) = [ \begin{matrix}0 & - {a}_{d , k} & {a}_{e , k} \\ {a}_{d , k} & 0 & - {a}_{n , k} \\ - {a}_{e , k} & {a}_{n , k} & 0\end{matrix} ] \qquad [ Equation 4 ]$$

where a_{n,k} is the magnitude of the acceleration signal in a north (N) axis direction, a_{e,k} is the magnitude of the acceleration signal in an east (E) axis direction, and a_{d,k} is the magnitude of the acceleration signal in a down (D) axis direction.

Furthermore, the EKF is applied to the error state vector and the dynamic model. The EKF includes time propagation (referred to as Predict) of Equation 5 to Equation 7 and measurement update of Equation 8 to Equation 10.

Thus, the state variables, that is, the errors may be estimated, and the estimated error may be removed, thereby accurately estimating an attitude and a position.

aₖ′ⁿ=c_{b}_{_{k|k−1}}ⁿ·aₖ′^{b} [Equation 5]

where aₖ′ⁿ is an acceleration value in the navigation frame, and aₖ′^{b} is an acceleration value in the body frame.

δX_{k|k-1}=ΦₖδX_{k-1|k-1}+Wₖ₋₁ [Equation 6]

where δX_{k|k-1} is an estimated error of state at a time point k based on a measurement value at a time point k−1, δX_{k-1|k-1} is an estimated error of state at the time point k−1 based on the measurement value at the time point k−1, and Wₖ₋₁ is an additive noise module of a process having a covariance Q(k).

P_{k|k-1}=Φk−1P_{k-1|k-1}Φₖ₋₁^{T}+Qₖ₋₁ [Equation 7]

where P_{k|k-1} is an estimated covariance at the time point k based on a measurement value at the time point k−1, P_{k'1|k-1} is an estimated covariance at the time point k−1 based on the measurement value at the time point k−1, and Φₖ₋₁ is a state transition matrix at the time point k−1.

zₖ=HδX_{k|k}+vₖ [Equation 8]

where zₖ is a linearized observation model, and vₖ is an additive noise model with a covariance Rₖ.

Kₖ=P_{k|k-1}H^{T}(HP_{k|k-1}H^{T}+Rₖ)⁻¹ [Equation 9]

where H is an observation matrix, and Kₖ is a near-optimal Kalman gain.

δX_{k|k}=δX_{k|k-1}+Kₖ·[mₖ−HδX_{k|k-1}] [Equation 10]

where mₖ is a measurement.

The conventional ZUPT that is used for the error estimation assumes that the speed of the pedestrian is zero while the shoe of the pedestrian is in contact with the ground (the locomotion interface device) as shown in Equation 11.

H=[0_{3×3} 0_{3×3} 0_{3×3} I_{3×3} 0_{3×3}]

mₖ=v_{k|k-1}−[0 0 0]′ [Equation 11]

However, when the pedestrian walks on the locomotion interface device, the ZUPT need be modified because the speed of the pedestrian is not zero while the shoe of the pedestrian is in contact with the locomotion interface device.

Thus, in the embodiments of the present invention, as shown in Equation 12, while the shoe of the pedestrian is in contact with the locomotion interface device (that is, during the stance phase), the step length is estimated based on the fact that the speed of the shoe is the same as the driving speed of the locomotion interface device (that is, applying the TPUT).

H=[0_{3×3} 0_{3×3} 0_{3×3} I_{3×3} 0_{3×3}]

mₖ=v_{k|k-1}−v_{ODM} [Equation 12]

where mₖ is a difference between the speed of the shoe that is estimated at the time point k and a driving speed of the locomotion interface device in the stance phase (that is, the speed of the shoe in the stance phase), and v_{ODM} is the driving speed of the locomotion interface device.

Meanwhile, the azimuth angle estimation may be performed based on data sensed by at least one of the first IMU and the second IMU.

When the azimuth angle is estimated based on the data sensed by the first IMU, the pedestrian position estimation apparatus may perform the azimuth angle estimation based on the error state vector and the dynamic model that are shown in Equation 2 to Equation 4.

When the azimuth angle is estimated based on the data sensed by the second IMU, the pedestrian position estimation apparatus may perform the azimuth angle estimation by configuring an attitude reference system (ARS) using an acceleration signal and a gyro signal that are received from the second IMU.

For example, as shown in Equation 13, the pedestrian position estimation apparatus configures an error state vector including the errors δ in the attitude φₖ and the gyro bias b_{g,k} as state variables based on the data sensed by the second IMU.

δXₖ=[δφₖ δb_{g,k}] [Equation 13]

Like in Equation 3, when the second IMU is formed of an MEMS sensor, the dynamic model may be simplified as shown in Equation 14.

$${Φ}_{k} = [ \begin{matrix}I & Δ t \cdot {C}_{{b}_{k \vert k - 1}}^{n} \\ 0 & I\end{matrix} ] \qquad [ Equation 14 ]$$

where Φₖ is a state transition matrix at the time point k, I is an identity matrix, Δt is a sampling time, and Cⁿ_{bk|k-1} is a direction cosine matrix.

Subsequently, the pedestrian position estimation apparatus may estimate the azimuth angle by applying the EKF to the error state vector and the dynamic model that are shown in Equation 13 and Equation 14.

The pedestrian position estimation apparatus performs step length correction and azimuth angle correction (405).

Since the locomotion interface device is driven while the pedestrian walks, that is, in the swing phase even when the step length of the pedestrian is estimated by applying the TUPT (403), a value different from a step length by which the pedestrian actually intends to move is estimated.

For example, as shown in FIG. 7A, when the pedestrian walks on a place other than the locomotion interface device, variation in the position of the shoe of the pedestrian may be the step length in the time period t0 to t1.

However, as shown in FIG. 7B, when the pedestrian walks on the locomotion interface device, the step length needs to be corrected in consideration of a driving distance of the locomotion interface device in the time period from t0 to t1 because the locomotion interface device is driven in an opposite direction to the heading of the pedestrian in the time period from t0 to t1. For example, as shown in Equation 15, a distance that the pedestrian actually intends to move may be calculated by integrating and then adding the driving speed of the locomotion interface device to the estimated step length.

That is, the step length by which the pedestrian actually intends to move may be calculated by compensating with a movement distance by which the pedestrian is moved by the locomotion interface device while the pedestrian walks.

r_{k,TRUE}=rₖ+v_{k,ODM}·dt [Equation 15]

where rₖ is a position of the shoe at the time point k, vₖ is a driving speed of the locomotion interface device at the time point k, and the r_{k,TRUE} is a corrected position of the shoe at the time point k.

Meanwhile, the pedestrian position estimation apparatus may correct the azimuth angle based on the estimated azimuth angle and the corrected step length. In order to correct the azimuth angle, first, the pedestrian position estimation apparatus may perform time synchronization between the estimated azimuth angle and the corrected step length. The pedestrian position estimation apparatus may correct the azimuth angle based on the time-synchronized data. For example, the correction of the azimuth angle may be a process of combining the time-synchronized pieces of data to obtain an azimuth angle having reduced errors. For example, when the position estimation is performed based on the estimated azimuth angle and the corrected step length from previous stages, different positions may be estimated depending on an error of each IMU. Accordingly, the pieces of data may be combined such that the estimated position of each IMU falls within a predetermined threshold range. Depending on embodiments, the process of correcting the azimuth angle may be omitted.

The pedestrian position estimation apparatus estimates a virtual position of the pedestrian, that is, a position of the pedestrian in the virtual reality space (407). The virtual position of the pedestrian may be estimated based on the heading (azimuth angle) and step length of the pedestrian that are estimated and corrected, respectively, in the previous stages. The estimated virtual position of the pedestrian may be continuously updated on the virtual reality, and the updated virtual positions of the pedestrian may be connected to form a moving route of the pedestrian.

One or two of the first IMUs that are used to estimate the step length and the azimuth angle may be attached to one or two shoes. Even when the step length information and the azimuth angle information that are associated with one shoe are given, the virtual position of the pedestrian may be estimated, but an accuracy of the estimation may be relatively low. Accordingly, on the assumption that a space between both shoes is constant, the virtual position may be estimated using the estimated step length of both the shoes and the estimated azimuth angle of the pedestrian and then applied to the virtual reality. Thus, the position of the pedestrian may be continuously updated from an initial position in the virtual reality.

Driving speed information of the locomotion interface device is required to apply the TUPT according to embodiments of the present invention. Thus, an encoder may be installed in a driving motor of the locomotion interface device, and the pedestrian position estimation apparatus according to an embodiment of the present invention may include a communication module for receiving the driving speed information from the encoder. Accordingly, the pedestrian position estimation apparatus may apply the TUPT based on speed information received from the encoder.

The encoder may be installed in each driving motor of the locomotion interface device. For example, the locomotion interface device may be implemented in one to three dimensions, the encoder may be installed in each driving motor for implementing the dimensions. For example, for a two-dimensional locomotion interface device that moves forward, backward, leftward, or rightward, two driving motors may be provided, and thus two encoders may be installed.

According to embodiments of the present invention, it is possible to estimate a distance actually traveled by a pedestrian and a position of the pedestrian in a virtual reality.

It is also possible to accurately estimate a step length and a heading of the pedestrian on a locomotion interface device.

It is still also possible to accurately estimate a position of the pedestrian in a virtual reality based on the estimated step length and heading of the pedestrian.

Furthermore, it is possible to maximize the immersion of the virtual reality.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of estimating a position of a pedestrian walking on a locomotion interface device, the method comprising:
detecting a stance phase based on first sensed data;
receiving driving speed information of the locomotion interface device from the locomotion interface device; and
estimating a step length of the pedestrian based on second sensed data, the step length being estimated in consideration of a driving speed of the locomotion interface device in the stance phase.

2. The method of claim 1, wherein the estimating of the step length of the pedestrian comprises estimating the step length of the pedestrian by applying a Kalman filter to the second sensed data.

3. The method of claim 1,
wherein the first sensed data includes gyro signal, and
the detecting of the stance phase comprises detecting, as the stance phase, a time period in which a magnitude of each gyro signal is less than a first threshold value and a variance of the gyro signals acquired during a predetermined time is less than a second threshold value.

4. The method of claim 3, wherein the first threshold value and the second threshold value are set in consideration of vibration generated by the locomotion interface device.

5. The method of claim 1, wherein the detecting of the stance phase comprises analyzing a signal pattern of the first sensed data to detect the stance phase.

6. The method of claim 1, wherein the second sensed data includes a gyro signal and an acceleration signal.

7. The method of claim 1, wherein the estimating of the step length comprises correcting a speed of the pedestrian in the stance phase to the driving speed of the locomotion interface device to estimate the step length.

8. The method of claim 7, further comprising correcting the estimated step length by adding a distance that the locomotion interface device is driven during a predetermined time period to a step length estimated during the time period.

9. The method of claim 8, further comprising estimating a position of the pedestrian in a virtual reality based on the corrected step length.

10. The method of claim 9, further comprising estimating a heading of the pedestrian based on the second sensed data,
wherein the estimating the position of the pedestrian comprises estimating the position of the pedestrian in the virtual reality in further consideration of the estimated heading.

11. An apparatus for estimating a position of a pedestrian walking on a locomotion interface device, the apparatus comprising:
a communication unit configured to receive a driving speed of the locomotion interface device from the locomotion interface device; and
a step length calculation unit configured to detect a stance phase based on first sensed data acquired by a first inertial measurement unit (IMU) and estimate a step length of the pedestrian based on second sensed data acquired by the first IMU, the step length being estimated in consideration of a driving speed of the locomotion interface device in the stance phase.

12. The apparatus of claim 11, wherein the step length calculation unit estimates the step length of the pedestrian by applying a Kalman filter to the second sensed data.

13. The apparatus of claim 11,
wherein the first sensed data includes gyro signal, and
the step length calculation unit detects, as the stance phase, a time period in which a magnitude of each gyro signal is less than a first threshold value and a variance of the gyro signals acquired during a predetermined time is less than a second threshold value.

14. The apparatus of claim 13, wherein the first threshold value and the second threshold value are set in consideration of vibration generated by the locomotion interface device.

15. The apparatus of claim 11, wherein the step length calculation unit analyzes a signal pattern of the first sensed data to detect the stance phase.

16. The apparatus of claim 11, wherein the second sensed data includes a gyro signal and an acceleration signal.

17. The apparatus of claim 11, wherein the step length calculation unit corrects a speed of the pedestrian in the stance phase to the driving speed of the locomotion interface device to estimate the step length.

18. The apparatus of claim 17, wherein the step length calculation unit corrects the estimated step length by adding a distance that the locomotion interface device is driven during a predetermined time period to a step length estimated during the time period.

19. The apparatus of claim 18, further comprising a virtual position estimation unit configured to estimate a position of a pedestrian in a virtual reality based on the corrected step length.

20. The apparatus of claim 19, further comprising an azimuth angle calculation unit configured to estimate a heading of the pedestrian based on third sensed data acquired by a second IMU,
wherein the virtual position estimation unit estimates the position of the pedestrian in the virtual reality in further consideration of the estimated heading.
